(19) United States
(12) Patent Application Publication
(10) Pub. No.: US 2008/0204601 A1
(43) Pub. Date: Aug. 28, 2008

(54) AC Coupling Techniques For Video Drivers

(75) Inventors: Chuanyang Wang, San Diego, CA (US); Francisco Ledesma, Dallas, TX (US); Alexander Herve Reyes, Richardson, TX (US)

Correspondence Address: TEXAS INSTRUMENTS INCORPORATED, P O BOX 655474, M/S 3999, DALLAS, TX, 75265, US

(73) Assignee: Texas Instruments, Dallas, TX (US)

(21) Appl. No.: 11/677,811

(22) Filed: Feb. 22, 2007

(51) Int. Cl. H04N 5/16

(52) U.S. Cl. 348/691; 348/E05.069

(57) ABSTRACT

A low bandwidth signal path is added to copy internal node DC signal to output node. Therefore, for a DC or low frequency signal, the output signal is controlled by this loop. On the other hand, a high frequency signal is not affected because of the low-bandwidth of added loop. Thus, both DC and AC coupling modes are realized for components such as low-voltage video drivers.

### BACKGROUND

Video drivers, or video amplifiers, supply or deliver video signals carried over an AC (alternating current) signal. A video driver should be able to deliver the video signal with high linearity to a consuming or receiving component and to match an inherent or characteristic impedance of a connecting cable to the receiving component. The receiving component may be a video receiver or what is commonly termed a TV (i.e., television). Video receivers or TVs may be part of various systems and devices that present or display video. Systems and devices that may have video drivers and video include wireless communication devices such as mobile or cellular telephones.

In many instances, it may be desirable or necessary for video drivers to consume a very small amount of power, while operating on a limited voltage supply. For example, devices such as those described above, may only provide or use a relatively small or limited power supply. Because of the limited power supply constraints of such devices, video drivers of such devices typically are required to consume a small amount of power. In other words, the video driver may not be able to draw too much power from a limited or small power supply.

Such low-voltage or low-power video drivers may typically couple a DC (direct current) signal to ground, or alternatively couple an AC signal to ground. In particular, the low-power video driver may either be DC coupled or AC coupled, depending on a cable that connects the video driver to the video receiver. In other words, the connecting cable may be either DC coupled or AC coupled. It may be typical that different applications or markets dictate the use of a DC coupled or AC coupled cable. In situations where the low-power video driver supports a DC coupling application, such a low-power video driver has no control of the DC level if it is driving an AC coupling cable. This results in a video signal that is unacceptably distorted.

### SUMMARY

In an embodiment, a component, such as video driver, provides a video signal that includes a DC component and AC component. The video signal is provided to a receiving component, such as a video receiver. For DC coupling mode, the video driver relies on a receiving component to establish the DC component. For AC coupling mode, where a cable that connects component to the receiving component, a capacitor prevents the DC component from traveling to the receiving component. Without correction of the DC component, the AC component in video signal is distorted. An internal signal path in the video driver is provided to establish the DC component at video driver such that AC component of video signal can pass through without distortion.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE CONTENTS

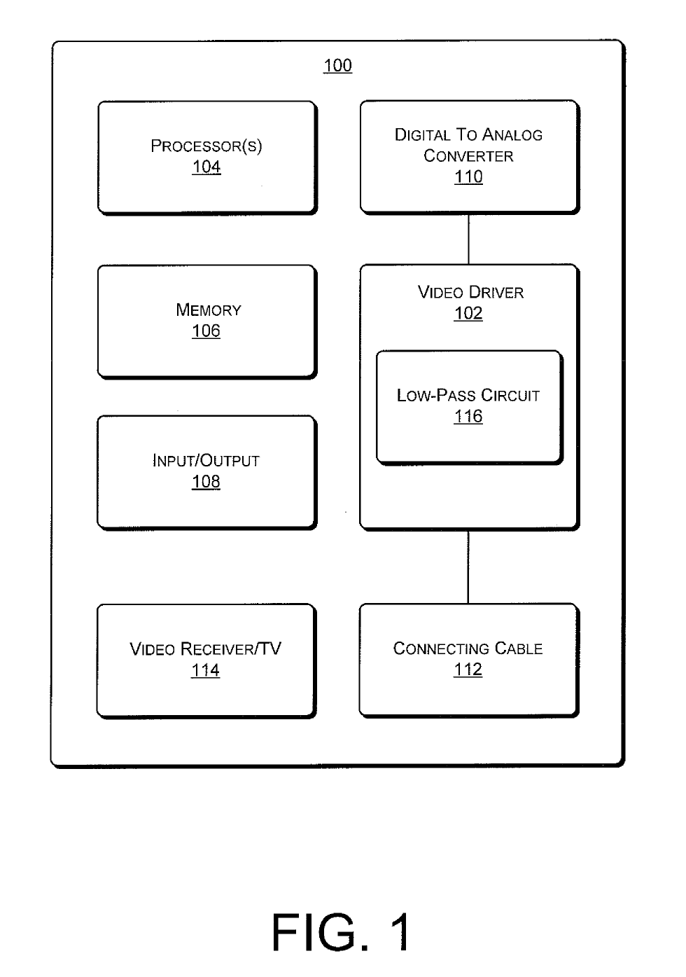

FIG. 1 illustrates a high level diagram of an exemplary system that implements AC coupling and DC coupling.

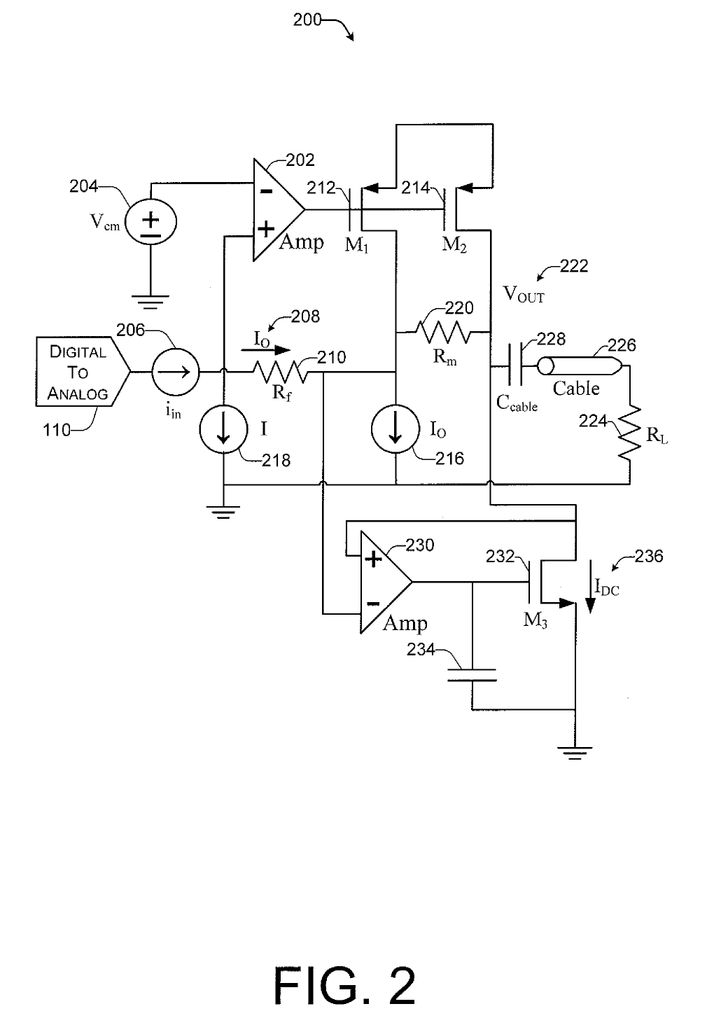

FIG. 2 illustrates an exemplary circuit diagram that provides AC coupling and DC coupling.

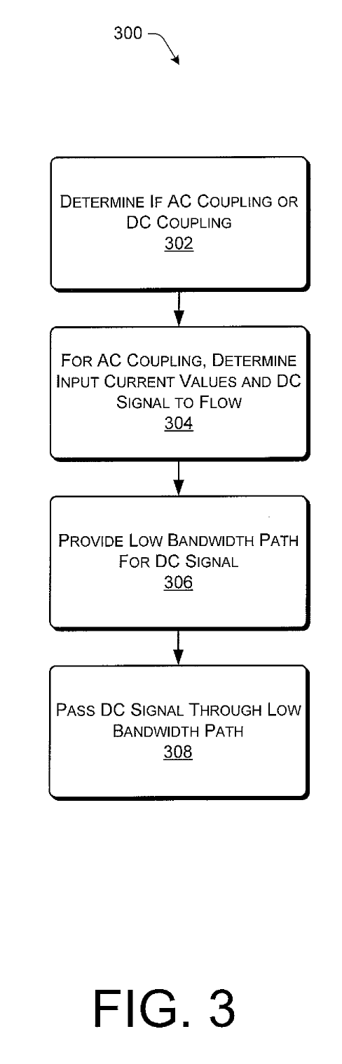

FIG. 3 is a flow diagram that describes steps in a method that provides AC coupling and DC coupling.

### DETAILED DESCRIPTION

FIG. 1 is an exemplary high level diagram of device or system 100 that supports AC coupling and DC coupling. In this example, the AC coupling and DC coupling support a video driver 102; however, it is contemplated that the AC coupling and DC coupling can support other components and applications. The system 100 represents an embodiment of various systems and devices, including but not limited to wireless communication devices such as mobile or cellular telephones; personal digital devices; audio/video entertainment devices; and generally devices that provide a video output displayed to a user.

The system 100 includes one or more controllers or processor(s) 104. Furthermore, the system 100 may include various memory components as represented by memory 106. Memory 106 may store machine or computer readable instructions and is accessed or controlled by processor(s) 104. Memory 106 may include read only memory (ROM), random access memory (RAM), flash memory, and various media (e.g., compact disk, digital versatile disk, etc.).

Various analog and/or digital data inputs and outputs are represented by input/output 108 which may be coupled to or controlled by processor(s) 104. In particular, input/output 108, includes an output to a video display or screen (not shown) which the video driver 102 supports.

A digital to analog converter (DAC) 110 may be included in system 100. The DAC 110 converts a digital signal into an output current signal. The output current (i.e. DAC output) may then be converted into voltage by an I-V (current to voltage) converter (not shown), where the voltage is fed or input into video driver 102. DAC 110 may include a current steering DAC to support an exemplary input bandwidth of 6 MHz received by system 100. A current steering DAC provides an advantage of speed and good performance in a relatively small form factor (i.e., less area).

The video driver 102 is a relatively low-power video driver working in a low voltage supply. An example power supply value of video driver 102 is approximately 1.8 volts. An example of video driver is described in co-pending patent application incorporated by reference herein: U.S. patent application Ser. No. 11/642,133, entitled Integrated Analog Video System, filed on Dec. 20, 2006, and assigned to Texas Instruments Incorporated. The video driver 102 is connected by a connecting cable 112 to a receiving component as represented by video receiver or TV 114 that consumes video data provided in a video signal from the video driver 102. The video receiver or TV 114 supports one of the outputs of input/output 108 for video. The connecting cable 112 may be either an AC coupled cable or a DC coupled cable.

A low-pass circuit 116 provides an additional signal path to copy a DC signal to output (i.e., input to video receiver or TV 114) so that DC level at the output (i.e., input to video receiver or TV 114) is decisively defined. Although the example describes the use of a video driver (i.e., video driver 102), other components and applications may make use of the low-pass circuit 116 and AC coupling. Examples of AC coupling include video equipment and devices that AC couple the output of a video signal, since it is a safer way to cross voltage domains. While DC coupling is accepted as being a more power efficient solution, there is a potential risk as two different power sources are not connected through a load. Therefore, examples of AC coupling are also applicable to systems that involve crossing across voltage domains.

FIG. 2 is an exemplary circuit 200 that provides AC and DC coupling for a component or circuit, such as a low-power video driver (e.g., video driver 102) discussed above. The video driver may include an amplifier 202 which receives a voltage input from a voltage source V_{cm} 204. The digital to analog converter 110 described above, provides a current iᵢₙ 206, with a current output value of I_{O} 208 that is received by resistor R_{f} 212 of the video driver. The video driver includes a pair of transistors M₁ 214 and M₂ 216. From M₁ 214 a summation of current (or current source) I_{O} 208, I₁ 218 and I₂ 216 is provided. The video driver further includes a resistor Rₘ 220. The video driver has an output voltage value of Vₒᵤₜ 222.

The receiving component (i.e., video receiver or TV 114) discussed above is represented by a resistor R_{L} 224. The connecting cable 112 discussed above is represented by cable 226. In AC coupling mode, the cable 226 has a capacitance represented by C_{cable} 228, where C_{cable} 228 may be inherent to cable 226. In DC coupling mode, C_{cable} 228 is not present.

The low-pass circuit 116 of FIG. 1 is presented by an amplifier 230, a transistor M₃ 232 and capacitor 234. The low-pass circuit along with the video driver may be provided as a separate module exclusive of DAC 110, cable 226 and receiving component or R_{L} 224.

In DC coupling mode, the amplifier 202 and transistor M₁ 212 realize or provide an I-V (current to voltage) conversion. A video signal which includes DC and AC information is established at the drain of transistor M₁ 212. The transistor M₂ 214 copies the current of M₁ 212 and sends it to cable 226. The resistor Rₘ 220 matches the characteristic impedance of the receiver cable 226. If the impedance is matched, no current flows through Rₘ 220.

In AC coupling mode, capacitor C_{cable} 228 is between cable 226 and output voltage Vₒᵤₜ 222. Therefore, no path exists for a DC signal establishment at Vₒᵤₜ. This may lead to a DC level at Vₒᵤₜ 222 that is not well defined. Furthermore, transistor M₂ 214 may not be able to work at normal condition. This leads to a video signal going to cable 226 that may be totally distorted. The additional low-pass circuitry as described above is added to form a DC signal path and establish the DC condition at Vₒᵤₜ 222. The DC level at Vₒᵤₜ 222 is well controlled and the video signal can be transmitted to cable 226 with high integrity. In particular, the amplifier 230 provides a low bandwidth signal path for the DC signal to flow, where the DC signal is represented by I_{DC} 236. I_{DC} 236 is a controlled amount of DC current, as determined by input values provided by the video driver (i.e., current iᵢₙ 206). Since amplifier 230 uses relatively low bandwidth, any additional power consumption of the DC coupling circuit is relatively negligible. Amplifier 230, capacitor 234, and transistor M₃ 232 form a closed loop to decisively control DC level at output equal to the DC component in video signal.

FIG. 3 shows a process 300 that provides for AC coupling and DC coupling for a video driver, other component or circuit, or application. In particular, in AC coupling mode, an internal low-pass path is provided to establish the DC component or DC signal in a video signal. The process 300 is illustrated as a collection of blocks in a logical flow graph, which represent a sequence of operations that can be implemented in hardware such as described above, software, firmware, or a combination thereof. Although described as a flowchart, it is contemplated that certain blocks may take place concurrently or in a different order.

At block 302, a determination is made if a cable connecting the video driver or other component, has a capacitance that necessitates AC coupling mode as describe above. If DC coupling mode is implemented, the video signal received at the cable may be allowed to simply pass through. As discussed above, if the video signal includes a DC component or DC signal that cannot pass through the capacitor of the cable, the DC signal is established at output.

At block 304, for AC coupling mode, a determination is made as to a current input value received by the video driver or component. The current input value determines the DC signal value to be passed or coupled in AC coupling mode from the cable.

At block 306, a low bandwidth path is provided for the DC signal. This low bandwidth signal path is a relatively low power consuming circuit relative to the video driver or component. An AC component or AC signal that carries actual video information is allowed to pass to the cable and is consumed by a receiving component such as a video receiver or TV.

At bock 308, the DC signal is established through the low bandwidth signal path.

### CONCLUSION

The above-described systems and methods describe supporting AC coupling mode and DC coupling mode for a video driver or other component that provides a video signal.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A circuit comprising:
a component that provides a video signal having an AC component and DC component, wherein the AC component includes video signal data received by a video receiver;
a cable that connects the component to the video receiver, wherein the cable includes a capacitor,
a low bandwidth signal path for the DC component to flow, allowing the DC component to bypass the capacitor.

2. The circuit of claim 1 wherein the component is a low-power video driver.

3. The circuit of claim 1 wherein the component receives a current input that determines the DC component that flows through the low bandwidth signal path.

4. The circuit of claim 1 wherein the capacitor of the cable supports an AC coupling mode.

5. The circuit of claim 1 wherein the low bandwidth signal path is provided to establish a DC condition for the circuit.

6. The circuit of claim 1 wherein the low bandwidth signal path is established through a low-bandwidth amplifier.

7. The circuit of claim 6 wherein the low bandwidth signal path further includes a transistor in which the DC component flows.

8. A device that provides video output comprising:
a processor;
inputs and outputs controlled by the processor;
a receiving component that consumes a video signal that includes an AC signal and DC signal, wherein the receiving component supports an output for video output; and
a low-pass circuit that provides a path for the DC signal of the video signal.

9. The device of claim 8 wherein the receiving component is a video receiver.

10. The device of claim 8 wherein the low-pass circuit provides the path for DC signal to copy the DC signal to the input to the receiving component, such that the input is decisively defined.

11. The device of claim 8 further comprising a digital to analog converter that converts a digital signal to an output current signal that includes the video signal.

12. The device of claim 11 wherein the current signal is converted to a voltage signal.

13. The device of claim 8 further comprising a video driver that provides the video signal to the receiving component.

14. The device of claim 13 farther comprising a cable that connects the video driver to the receiving component, wherein the cable includes a capacitor for AC coupling, the low-pass circuit establishing the DC signal that does not flow through the capacitor.

15. An AC coupling method comprising:
determining if AC coupling mode is to be implemented based on a cable that connects a component to a video receiver;
determining a current value at the component, wherein the current value determines a value for a DC signal to be established; and
providing a signal path for the DC signal.

16. The method of claim 15, wherein the determining is based on a capacitance at the cable that does not allow the DC signal to pass through the cable.

17. The method of claim 15, wherein if AC coupling mode is not to be implanted, allowing the DC signal, along with an AC signal, to pass through the cable.

18. The method of claim 15, wherein the determining a current value is based on a current value received by the component.

19. The method of claim 18, wherein the DC signal and the AC signal comprise a video signal provided by the component, wherein the component is a video driver.

20. The method of claim 15, wherein the signal path is a low-bandwidth signal path.
